(19) United States
(12) Patent Application Publication
(10) Pub. No.: US 2021/0282561 A1
(43) Pub. Date: Sep. 16, 2021

(54) ARM BRACE

(71) Applicant: Reynaldo Sandoval, Pasadena, TX (US)

(72) Inventor: Reynaldo Sandoval, Pasadena, TX (US)

(21) Appl. No.: 16/814,866

(22) Filed: Mar. 10, 2020

(51) Int. Cl. A47C 16/00; F16B 1/00

(52) U.S. Cl. CPC A47C 16/00; F16B 2001/0035; F16B 1/00

(57) ABSTRACT

An arm brace of the present disclosure includes a first extension section and a second extension section. First extension section and second extension section may be connected via an elbow. Second extension section may be connected to a brace which connects to one or more magnets.

### BACKGROUND OF THE DISCLOSURE

### Field of the Invention

This disclosure is generally directed to arm braces to be used for arm support while working; including while welding.

### Description of the Related Art

Arm support while working for extended periods of time is important in many lines of work. It is known that arm support for extended periods of time for work equipment, for example, welding equipment while welding can be very difficult. A symptom of such arm fatigue would include an inability to hold equipment steadily.

This is a particular problem in welding where the arms of the welder must be held steady for extended periods of time and frequently while the welder may be in a difficult or unusual position, i.e. lying down, bending over, or welding at a place above their head. Accordingly, there is a need for improved arm support, in particular, for workers and for welders.

### SUMMARY OF THE INVENTION

An arm brace of the present disclosure includes a first extension section and a second extension section. First extension section and second extension section may be connected via an elbow. Second extension section may be connected to a brace which connects to one or more magnets.

Other features and aspects will be apparent from the following detailed description, the drawings, and the claims

### BRIEF DESCRIPTION OF THE DRAWINGS

FIG. 1 shows one embodiment of an arm brace of the present disclosure.

FIG. 2 shows one example of a user using an arm brace of the present disclosure.

FIG. 3 shows another example of a user using an arm brace of the present disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The welding arm brace of the present disclosure can be used to make over-head welds and vertical welds. The arm brace will help improve welding skills on overhead by 80% or more and with this brace a user may steady their arm by 100%. A welder can also make better quality welds when using the disclosed welding arm brace.

A user can make overhead welds look like they were welded flat consistently every time. That represents a significant improvement over conventional methods. The arm brace also helps with X-ray on pipe. The disclosed arm brace, in embodiments, can also hold a welding whip and stick rods.

The arm brace of the present disclosure may be made of a variety of materials including metals, hard plastics, composites, etc. Any material known in the art to provide sufficient strength for an arm brace is contemplated.

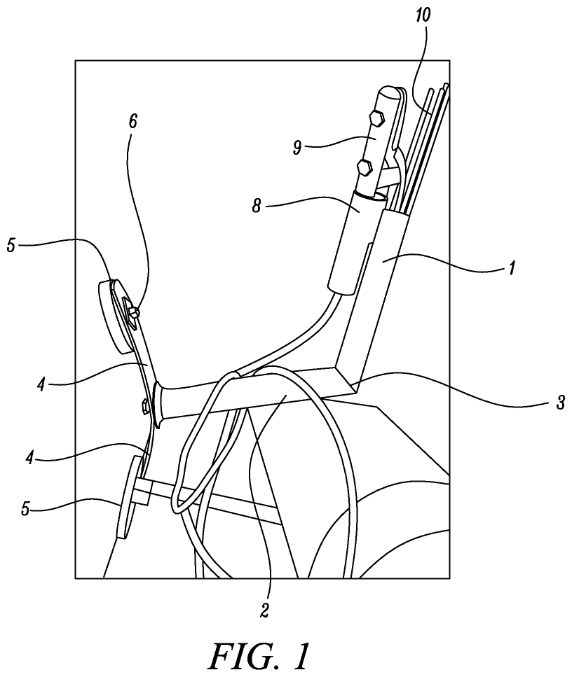

FIG. 1 shows one embodiment of an arm brace of the present disclosure. FIG. 1 shows arm brace with extension section 1 and extension section 2. Extension section 1 and extension section 2 may be connected via elbow 3. Elbow 3 may be integral with extension section 1 and extension section 2. The elbow may also be a joint or connector connecting two separate extension sections in a like configuration. The angle of elbow 3 may a little more than 90° as shown in FIG. 1 although the arm brace is not limited thereto. The angle of the elbow may range from about 90° to about 175°. An angle somewhat greater than 90° is preferred. Preferably the angle of the elbow may be between 90° and 135°.

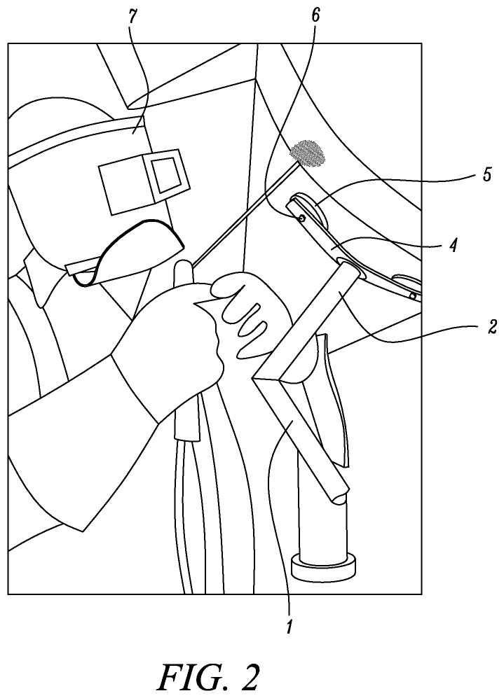

Extension section 2 is connected to brace 4 and which connects to one or more magnets 5. Magnets 5 are connected to brace 4 by bolts 6 in FIG. 1 but may generally be connected by any convenient means known and commonly used in the art for such connections. FIG. 2 further shows holder 8, and welding whip 9.

FIG. 1 also shows an embodiment wherein extension section 1 may be hollow and thus able to hold, for example, accessories including welding stick rods 10.

FIG. 2 shows one embodiment of a welder 7 making a weld with an arm brace of the present disclosure.

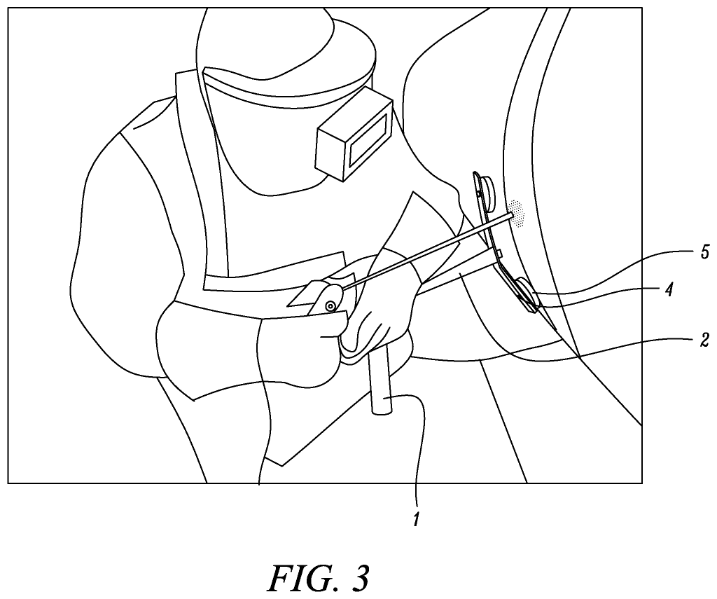

FIG. 3 shows another example of a welder 7 making a weld with an arm brace of the present disclosure.

While this disclosure includes specific examples, it will be apparent after an understanding of the disclosure of this application has been attained that various changes in form and details may be made in these examples without departing from the spirit and scope of the claims and their equivalents.

What is claimed is:

1. An arm brace comprising:
a first extension section;
a second extension section connected to the first extension via an elbow;
a brace connected to the second extension section;
one or more magnets connected to the brace.

2. The arm brace of claim 1, wherein the elbow is integral with the first extension section and the second extension section.

3. The arm brace of claim 1, wherein the angle of the elbow connecting the first extension section and the second extension section is between 90° and 175°.

3. The arm brace of claim 1, wherein the angle of the elbow connecting extension section and the second extension section is between 90° and 135°.

4. The arm brace of claim 1, wherein the first extension comprises a hollow section configured to hold welding accessories.

5. The arm brace of claim 1, wherein the number of magnets is two.
